(19) United States
(12) Patent Application Publication
(10) Pub. No.: US 2025/0132359 A1
(43) Pub. Date: Apr. 24, 2025

(54) HYDROGEN PURGE SYSTEM AND METHOD FOR CONTROLLING THE SAME

(71) Applicants: Hyundai Motor Company, Seoul (KR); Kia Corporation, Seoul (KR)

(72) Inventors: Gyu Young Kim, Yongin-si (KR); In Tae Park, Seoul (KR)

(21) Appl. No.: 18/432,701

(22) Filed: Feb. 5, 2024

(30) Foreign Application Priority Data
Oct. 19, 2023 (KR) 10-2023-0139991

(51) Int. Cl. H01M 8/04223; B60L 50/72; B60L 58/30; F16K 24/04; H01M 8/0438; H01M 8/0444; H01M 8/04664; H01M 8/04746; H01M 8/04858

(52) U.S. Cl. CPC H01M 8/04231; B60L 50/72; B60L 58/30; F16K 24/04; H01M 8/04432; H01M 8/04447; H01M 8/04664; H01M 8/04753; H01M 8/04895; H01M 8/04949; H01M 2250/20

(57) ABSTRACT

An embodiment of the present disclosure provides a hydrogen purge system and a method for controlling the same, which are capable of maintaining the hydrogen purge amount constant based on differential pressure between an anode and a cathode, regardless of the size of a hydrogen purge flow path of a purge valve, by allowing the opening degree of the purge valve to the hydrogen purge flow path to be adjusted by a current control or PWM control according to a mapping of the differential pressure between the anode and the cathode of a fuel cell stack.

### CROSS-REFERENCE TO RELATED APPLICATIONS

This application claims the benefit of Korean Patent Application No. 10-2023-0139991, filed on Oct. 19, 2023, which application is hereby incorporated herein by reference.

### TECHNICAL FIELD

The present disclosure relates to a hydrogen purge system for a fuel cell system.

### BACKGROUND

A fuel cell system mounted on a fuel cell vehicle can include a fuel cell stack in which multiple unit cells are stacked to generate electricity using electrochemical reactions of hydrogen and oxygen, a hydrogen supply system for supplying hydrogen (fuel) to the fuel cell stack, an air supply system for supplying oxygen in the air, which is an oxidizing agent necessary for electrochemical reactions, to the fuel cell stack, and a heat and water management system, which removes electrochemical reaction heat from the fuel cell stack while controlling operating temperature or the like.

During the operation of such fuel cell system, the hydrogen that has passed from a hydrogen tank through a regulator and a hydrogen supply valve is supplied to an anode of the fuel cell stack through an ejector, and then completes the reaction to generate electricity. Some of the hydrogen is recycled to the anode and the rest is discharged to the outside through a purge valve to form a hydrogen purge.

The hydrogen purge by which hydrogen is discharged to the outside through the purge valve can be performed periodically to manage the hydrogen concentration of the anode at a certain level and to discharge remaining condensate water in the anode.

A conventional purge valve can include a body portion having a hydrogen purge flow path, a diaphragm that opens and closes the hydrogen purge flow path, and a drive unit that drives the diaphragm to open or close according to powering on/off.

Accordingly, the hydrogen purge flow path may be opened by the opening operation of the diaphragm when the power to the drive unit is turned on, and the hydrogen purge flow path may be closed by the closing operation of the diaphragm when the power to the drive unit is turned off.

In the open state of the hydrogen purge flow path due to powering on the drive unit of the purge valve, the hydrogen purge amount may be determined in proportion to the size of the hydrogen purge flow path and the differential pressure between the anode and the cathode of the fuel cell stack.

However, when the differential pressure between the anode and the cathode of the fuel cell stack momentarily becomes overpressure, the hydrogen purge amount discharged from the anode increases excessively, making it difficult to manage the hydrogen concentration of the anode at a certain level.

In addition, when the differential pressure between the anode and the cathode is larger than the appropriate range, as the size of the hydrogen purge flow path of the purge valve increases, the hydrogen purge amount increases excessively, which can be problematic in that hydrogen consumption may increase and the error for estimating hydrogen concentration (estimating hydrogen purge amount) within the fuel cell stack greatly increases.

Contrarily, when the differential pressure between the anode and the cathode is smaller than the appropriate range, as the size of the hydrogen purge flow path of the purge valve deceases, the amount of water discharged together with hydrogen from the anode decreases, which can be problematic in that a flooding phenomenon occurs due to an increase in the amount of water remaining in the fuel cell stack.

### SUMMARY

The present disclosure relates to a hydrogen purge system and a method for controlling the same, and more specifically, to a hydrogen purge system and a method for controlling the same, which are capable of constantly determining the hydrogen purge amount discharged from a fuel cell stack by adjusting the opening amount through the adjustment of the opening and closing stroke of a purge valve.

An embodiment of the present disclosure can address the above-described conventional drawbacks. In an embodiment, a hydrogen purge system, and a method for controlling the same, can maintain the hydrogen purge amount constant for each differential pressure between an anode and a cathode regardless of the size of a hydrogen purge flow path of a purge valve, by allowing the opening degree of the purge valve to the hydrogen purge flow path to be adjusted by a current control or PWM control according to the differential pressure between the anode and the cathode of a fuel cell stack.

An implementation or embodiment of the present disclosure provides a hydrogen purge system including a fuel cell stack, a purge valve having a hydrogen purge flow path and mounted on a hydrogen outlet of an anode of the fuel cell stack, and a controller configured to perform a current control or PWM control on the purge valve to adjust an opening degree of the hydrogen purge flow path of the purge valve according to a differential pressure between the anode and a cathode of the fuel cell stack.

In an embodiment, the purge valve can include a valve housing with the hydrogen purge flow path formed therein and configured to communicate with the hydrogen outlet of the anode, a drive unit case mounted on the outside of the valve housing, a coil that is mounted on the inner diameter of the drive unit case, and to which current is applied by the current control or PWM control of the controller, a plunger disposed so as to be movable forward and backward in the center of the drive unit case, and a diaphragm mounted on a front end of the plunger to adjust the opening degree of the hydrogen purge flow path by the forward and backward stroke of the plunger according to the amount of current applied to the coil, wherein a ventilation hole penetrates through the valve housing and the drive unit case to maintain the internal space of the drive unit case at atmospheric pressure.

The controller can be configured to perform the current control or PWM control on the coil of the purge valve using current-hydrogen purge amount mapping data for each differential pressure between the anode and the cathode after checking the differential pressure between the anode and the cathode.

The ventilation hole in the valve housing can penetrate through a region between a first O-ring for sealing the internal space of the valve housing and a second O-ring for sealing the hydrogen purge flow path.

Additionally, a vent hole can be in the valve housing to communicate the ventilation hole with the atmosphere.

Additionally, the vent hole can be equipped with a membrane filter for preventing reverse infiltration of moisture.

In an implementation or embodiment of the present disclosure, a method for controlling a hydrogen purge system includes checking, by a controller, a differential pressure between an anode and a cathode of a fuel cell stack, determining, by the controller, the amount of current to be applied to a purge valve based on current-hydrogen purge amount mapping data for each differential pressure between the anode and the cathode, applying the determined amount of current to a coil of the purge valve by a current control or PWM control of the controller, and adjusting the opening degree of a hydrogen purge flow path of the purge valve by the forward and backward stroke of a plunger according to the amount of current applied to the coil of the purge valve.

The opening degree of the hydrogen purge flow path can be adjusted by a diaphragm mounted on a front end of the plunger and by the forward and backward stroke of the plunger according to the amount of current applied to the coil.

If the hydrogen concentration of the fuel cell stack is less than a lower limit reference value, the controller can check a differential pressure between an anode and a cathode, and if the hydrogen concentration of the fuel cell stack is greater than an upper limit reference value after the opening degree of the hydrogen purge flow path is adjusted, the controller can perform an off control for closing the purge valve.

In an embodiment, the purge valve can include a valve housing having the hydrogen purge flow path, and a drive unit case with the coil and the plunger installed therein, and the internal space of the drive unit case can be maintained at atmospheric pressure by a ventilation hole in the valve housing and the drive unit case, and a vent hole in the valve housing to communicate with the ventilation hole.

In an embodiment, the controller can determine that the purge valve fails if a phenomenon occurs consecutively five or more times that the amount of fluid containing hydrogen and water discharged to the outside through the hydrogen purge flow path does not exceed a reference amount after the opening degree of the hydrogen purge flow path is adjusted through the current control or PWM control for the purge valve.

In an embodiment, the controller can determine that the purge valve fails if a phenomenon occurs consecutively five or more times that the amount of fluid containing hydrogen and water discharged to the outside through the hydrogen purge flow path exceeds a reference amount after the opening degree of the hydrogen purge flow path is adjusted through the current control or PWM control for the purge valve.

In an embodiment, the controller can determine that the purge valve fails if a phenomenon occurs consecutively five or more times that fluid containing hydrogen and water is not discharged through the hydrogen purge flow path after the opening degree of the hydrogen purge flow path is adjusted through the current control or PWM control for the purge valve.

In an embodiment, the controller can determine that the purge valve fails if a phenomenon occurs consecutively five or more times that fluid containing hydrogen and water is discharged through the hydrogen purge flow path after an off control for closing the purge valve.

By solving the above problems, an embodiment of the present disclosure can provide the following effects.

First, in an embodiment, it is possible for the hydrogen purge amount discharged from the fuel cell stack to be maintained constant for each differential pressure between an anode and a cathode, by allowing the opening degree of the purge valve to the hydrogen purge flow path to be adjusted by a current control or PWM control according to the differential pressure between the anode and the cathode of a fuel cell stack.

Second, in an embodiment, by having the ventilation hole and the vent hole in the valve housing and the drive unit case of the purge valve to maintain the internal space of the drive unit case at atmospheric pressure, the forward and backward stroke movement of the plunger and the opening and closing operations of the diaphragm for the hydrogen purge flow path according to the amount of current applied to the coil of the purge valve can be performed consistently and smoothly.

Third, in an embodiment, regardless of the size of the hydrogen purge flow path of the purge valve, the hydrogen purge amount discharged from the fuel cell stack can be adjusted consistently for each differential pressure between the anode and the cathode, so it is possible to prevent an increase in hydrogen consumption due to the conventional excessive increase in the hydrogen purge amount, and at the same time to minimize the error for estimating the hydrogen concentration in the fuel cell stack (estimating the hydrogen purge amount).

Fourth, in an embodiment, regardless of the size of the hydrogen purge flow path of the purge valve, the hydrogen purge amount discharged from the fuel cell stack can be adjusted consistently for each differential pressure between the anode and the cathode, so water can be smoothly discharged along with hydrogen from the anode, and thus the flooding phenomenon within the fuel cell stack can be prevented.

### BRIEF DESCRIPTION OF THE DRAWINGS

The above and other features and advantages of the present disclosure will now be described in detail with reference to certain examples thereof illustrated in the accompanying drawings, which are given herein below by way of illustration, and thus are not necessarily limitative of the present disclosure, and wherein:

FIG. 1 is a graph comparing an existing hydrogen purge method and a hydrogen purge method of an embodiment of the present disclosure;

FIG. 2 is a front view showing a purge valve of a hydrogen purge system according to an embodiment of the present disclosure;

FIG. 3 is a side cross-sectional view showing a purge valve of a hydrogen purge system according to an embodiment of the present disclosure;

FIG. 4 is a side cross-sectional view showing an example purge valve of a hydrogen purge system according an embodiment of to the present disclosure mounted on a hydrogen outlet of an anode of a fuel cell stack;

FIG. 5 is a graph showing current-hydrogen purge amount mapping data for various differential pressures between an anode and a cathode used in a method for controlling a hydrogen purge system according to an embodiment of the present disclosure; and

FIG. 6 is a flowchart showing a control method of a hydrogen purge system according to an embodiment of the present disclosure.

### DETAILED DESCRIPTION OF ILLUSTRATIVE EMBODIMENTS

Specific structural or functional descriptions described in the embodiments of the present disclosure are provided by way of example for the purpose of describing embodiments according to the present disclosure, and embodiments may be realized in various forms, and additionally, the disclosure should not necessarily be construed as being limited by the embodiments described herein, but should be understood as including all changes, equivalents, and substitutes included in the technical ideas and scope of the present disclosure.

As used herein, terms such as “first,” “second,” and the like, may be used to explain various components, but the components are not necessarily limited by these terms. The above terms can be used for the purpose of distinguishing one component from other components. For example, the first component can be designated as the second component without departing from the scope of the present disclosure, and, similarly, the second component can also be designated as the first component.

Hereinafter, an embodiment of the present disclosure will be described in detail with reference to the accompanying drawings.

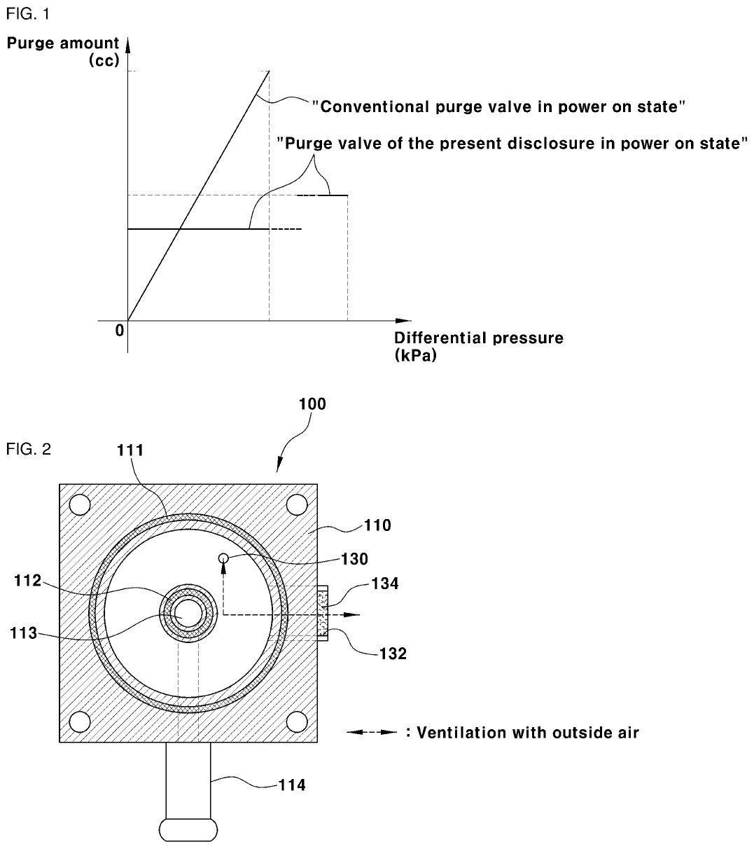

Referring to FIG. 1, in the open state of a hydrogen purge flow path according to powering on a conventional purge valve, the hydrogen purge amount can be determined in proportion to the differential pressure between an anode and a cathode of a fuel cell stack, so that the hydrogen purge amount (cc) increases with the increasing differential pressure (kPa) between an anode and a cathode.

An embodiment of the present disclosure can be characterized in that by allowing the opening degree of the purge valve to the hydrogen purge flow path to be adjusted by a current control or PWM control according to the differential pressure between the anode and the cathode of a fuel cell stack, it is possible for the hydrogen purge amount discharged from the fuel cell stack to be maintained constant, as shown in FIG. 1, for each differential pressure between an anode and a cathode.

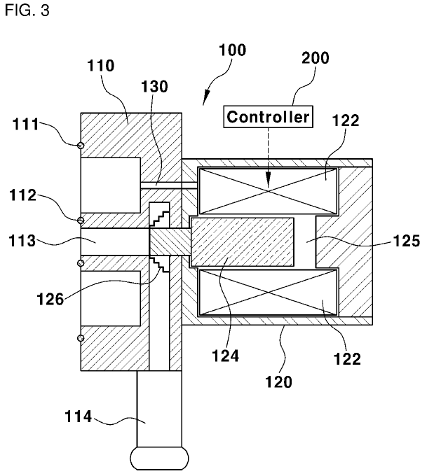

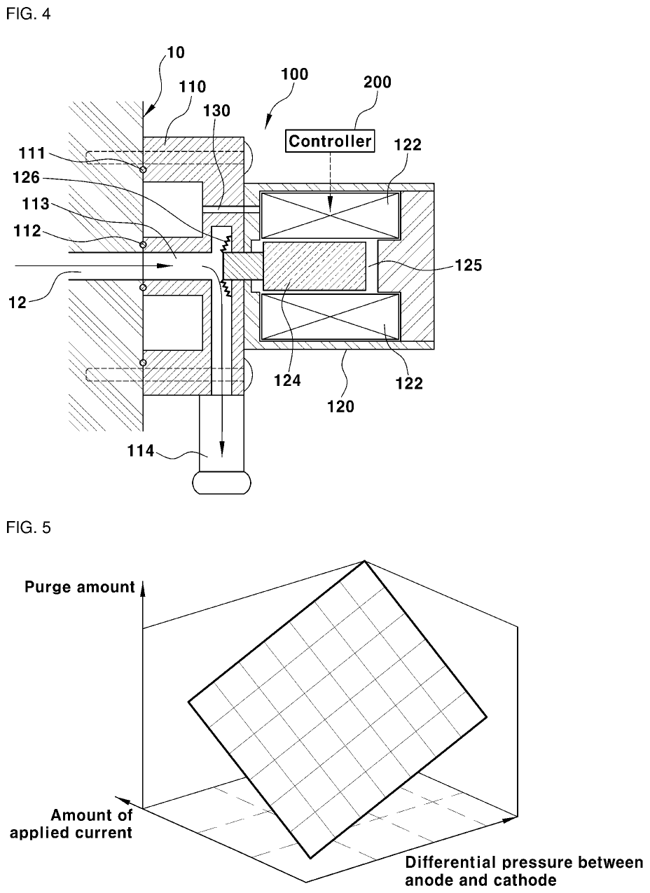

FIGS. 2 and 3 are front and side cross-sectional views, respectively, showing a purge valve of a hydrogen purge system according to an embodiment of the present disclosure. FIG. 4 is a side cross-sectional view showing an example in which the purge valve of the hydrogen purge system according to an embodiment of the present disclosure is mounted on a hydrogen outlet of an anode of a fuel cell stack.

Referring to FIG. 4, a purge valve 100 having a hydrogen purge flow path 113 is mounted on a hydrogen outlet 12 of an anode of a fuel cell stack 10.

As shown in FIGS. 2-4, the purge valve 100 can include as its framework a valve housing 110 with the hydrogen purge flow path 113 formed therein and communicating with the hydrogen outlet 12 of the anode, and a drive unit case 120 mounted on the outside of the valve housing 110.

The front end of the hydrogen purge flow path 113 can communicate with the hydrogen outlet 12 of the anode, and the rear end of the hydrogen purge flow path 113 can be connected with an external discharge pipe 114.

The drive unit case 120 can be a type of solenoid case, and a coil 122 can be mounted on its inner diameter part, and current can be applied to this coil 122 by a current control or pulse-width modulation (PWM) control of a controller 200, for example.

Further, a plunger 124 can be surrounded by the coil 122 and configured to be movable forward and backward in the center of the drive unit case 120.

Accordingly, when current is applied to the coil 122 by the current control or PWM control of the controller 200, the plunger 124 can move forward and backward by a set or predetermined stroke based on known solenoid principles.

The forward and backward stroke length of the plunger 124 may be determined according to the amount of current applied to the coil 122 by the current control or PWM control of the controller, for example.

In addition, a diaphragm 126 can be mounted on the front end of the plunger 124 for adjusting the opening degree (opening amount) of the hydrogen purge flow path 113 or closing the hydrogen purge flow path.

Accordingly, the diaphragm 126 can move forward and backward together with the plunger 124 by the forward and backward stroke of the plunger 124 according to the amount of current applied to the coil 122. The opening degree (opening amount) of the hydrogen purge flow path 113 can be adjusted, or when the current applied to the coil 122 is turned off, the plunger 124 can be pulled and moved forward to the maximum due to the elastic restoring force in the expansion direction of the diaphragm 126, such that the diaphragm 126 closes the hydrogen purge flow path 113.

A ventilation hole 130 can be through the valve housing 110 and the drive unit case 120 to maintain the internal space 125 of the drive unit case 120 at atmospheric pressure, and a vent hole 132 can be in the valve housing 110 to communicate the ventilation hole 130 with the atmosphere.

The ventilation hole 130 can be communicatively formed in the outer wall of the valve housing 110 and the inner wall of the drive unit case 120, which can be in close contact with each other.

The inner space 125 of the drive unit case 120 behind the plunger 124 can fluidly communicate with the atmosphere through the ventilation hole 130 and the vent hole 132, and can be maintained at atmospheric pressure.

Bringing the internal space 125 of the drive unit case 120 to atmospheric pressure can enable smooth forward and backward stroke movement of the plunger 124 according to the amount of current applied to the coil 122.

If the internal space 125 of the drive unit case 120 is not close to or equal to atmospheric pressure, a pressure change may occur in the internal space 125 of the drive unit case 120 due to a temperature change caused by various factors (e.g., current applied to the coil, external temperature, etc.), preventing or reducing smooth forward and backward movement of the plunger 124, and as a result, the forward and backward stroke movement of the plunger 124 according to the amount of current applied to the coil 122 is not performed smoothly.

For example, the volume V of the internal space 125 of the drive unit case can be fixed, but the temperature T of the internal space 125 can change depending on the current applied to the coil according to the solenoid operating principle and the surrounding environment temperature, and if the temperature in the internal space 125 becomes high after a certain period of time, the pressure P of the internal space 125 can eventually increase according to the formula “PV=nRT” due to the increase in the temperature T of the internal space 125 with the volume V of the internal space 125 being fixed.

When the pressure in the internal space 125 of the drive unit case increases, force can be applied to the plunger 124 in the forward direction (closing direction), thereby causing the forward and backward stroke movement of the plunger 124 according to the amount of current applied to the coil 122 to be inconsistent, and thus causing the response speed at which the diaphragm 126 mounted on the plunger 124 opens and closes the hydrogen purge flow path 113 to be also inconsistent, eventually resulting in an imbalance in the hydrogen purge amount discharged through the hydrogen purge flow path 113.

Accordingly, by enabling the inner space 125 of the drive unit case 120 behind the plunger 124 to communicate with the atmosphere through the ventilation hole 130 and the vent hole 132 and to be maintained at atmospheric pressure, the forward and backward stroke movement of the plunger 124 and the opening and closing operations of the diaphragm 126 for the hydrogen purge flow path according to the amount of current applied to the coil 122 can be performed consistently and smoothly.

The ventilation hole 130 formed in the valve housing 110 can, as shown in FIG. 4, penetrate through the outer wall of the valve housing 110 in close contact with the drive unit case 120 in the region between a first O-ring 111 sealing the inner space of the valve housing 110 and a second O-ring 112 sealing the hydrogen purge flow path 113 because this configuration is capable of preventing moisture and the like from infiltrating into the drive unit case 120 through the ventilation hole 130.

To put it more elaborately, if the ventilation hole 130 was not maintained watertight, the coil 122 and the plunger 124 might be corroded due to the moisture infiltration into the drive unit case 120 through the ventilation hole 130, but the first O-ring inl can block moisture and the like from infiltrating into the ventilation hole 130 from the outside, and the second O-ring 112 can blocks hydrogen and condensate water from infiltrating into the ventilation hole 130 from the hydrogen purge flow path 113. By blocking moisture from infiltrating into the drive unit case 120 through the ventilation hole 130, the parts within the drive unit case 120 can be easily protected without corrosion.

In addition, a membrane filter 134 can be installed inside the vent hole 132 to prevent reverse infiltration of moisture, so that moisture, foreign substances, and the like, infiltrating into the vent hole 132 from the outside are filtered out by the membrane filter 134. Therefore, it is possible to block or hinder moisture, foreign substances, and the like, from infiltrating into the ventilation hole 130 and the drive unit case 120 from the outside.

The controller 200 can be configured to perform the current control or PWM control on the coil 122 of the purge valve 100 to adjust the opening degree of the hydrogen purge flow path of the purge valve according to the differential pressure between the anode and the cathode of the fuel cell stack.

The controller 200 can be configured to perform the current control or PWM control on the coil 122 of the purge valve 100 using current-hydrogen purge amount mapping data for each differential pressure between the anode and the cathode after checking the differential pressure between the anode and the cathode.

The controller 200 can be configured to perform fail-safe control for determining failure of the purge valve 100.

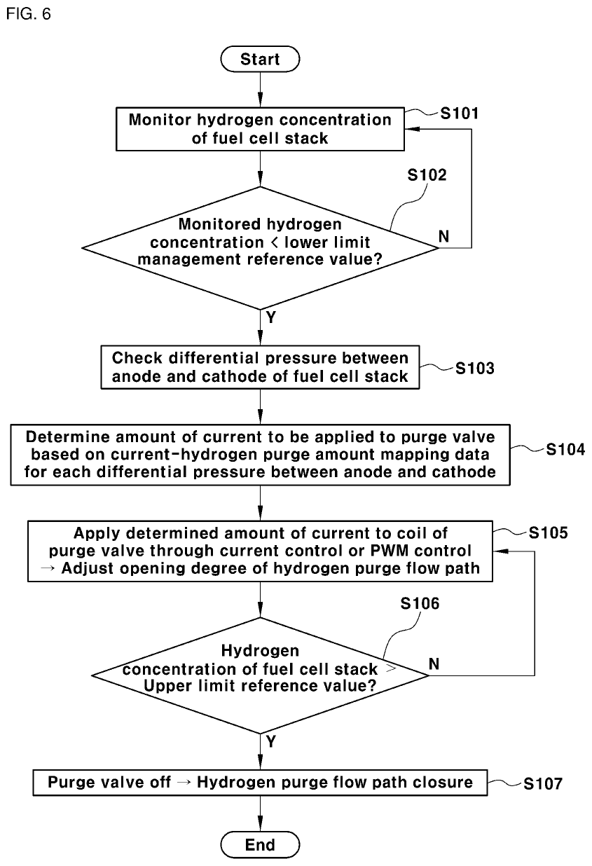

A description of a hydrogen purge system control method according to an embodiment of the present disclosure based on the above-described configuration follows. FIG. 6 is a flowchart showing a control method of a hydrogen purge system according to an embodiment of the present disclosure.

At operation S101, the hydrogen concentration of a fuel cell stack can be monitored.

For example, the controller 200 may monitor the hydrogen concentration of the fuel cell stack by receiving a signal indicative of measurements made by a concentration measurement sensor (not shown) of the fuel cell stack.

At operation S102, the hydrogen concentration monitored in operation S101 described above can be compared with a lower limit management reference value.

For example, the controller 200 may compare the present hydrogen concentration of the stack with the lower limit management reference value.

If the present hydrogen concentration of the stack is lower than the lower limit management reference value, then to increase the hydrogen concentration in the anode of the stack, condensate water, nitrogen, and the like, remaining in the anode of the stack can be purged to the outside along with the hydrogen remaining in the anode of the stack in a state where hydrogen is supplied to the anode of the stack because the condensate water, nitrogen, and the like, remaining in the anode of the stack can cause the hydrogen concentration to decrease.

If the hydrogen concentration of the fuel cell stack is less than the lower limit reference value as a result of the comparison in operation S102 described above, the controller 200 can check the differential pressure between the anode and the cathode of the stack (operation S103).

For example, the controller 200 may receive a signal indicative of measurements made by a pressure sensor (not shown) of the fuel cell stack to check the differential pressure between the anode and the cathode of the stack.

At operation S104, the controller 200 can determine the amount of current to be applied to the purge valve based on the current-hydrogen purge amount mapping data for each differential pressure between the anode and the cathode.

For example, the current-hydrogen purge amount mapping data may be pre-built in the form of a table in which, as shown in FIG. 5, the differential pressure between the anode and the cathode, the amount of current applied to the coil by the current control or PWM control of the controller, and the hydrogen purge amount are set to the X-axis, Y-axis, and Z-axis, respectively, and may be stored for use by the controller 200.

At operation S105, the amount of current determined in operation S104 described above can be applied to the coil 122 of the purge valve 100 by the current control of the controller 200, or the amount of current determined in operation S104 described above is applied to the coil 122 of the purge valve 100 in a duty manner by the PWM control of the controller 200, for example.

Accordingly, when current is applied to the coil 122 by the current control or PWM control of the controller 200, the plunger 124 can move forward and backward by a set or predetermined stroke, and at the same time, the diaphragm 126 mounted on the front end of the plunger 124 can be moved forward and backward, and the opening degree (opening amount) of the hydrogen purge flow path 113 can be adjusted by the forward and backward movement of the diaphragm 126.

The purge valve 100 can include a valve housing 110 having the hydrogen purge flow path 113, and a drive unit case 120 with the coil 122 and the plunger 124 installed therein, and the internal space of the drive unit case 120 can be maintained at atmospheric pressure without pressure change by the ventilation hole 130 formed in the valve housing 110 and the drive unit case 120, and by the vent hole 132 in the valve housing 110 to fluidly communicate with the ventilation hole, as described above.

Accordingly, the forward and backward stroke movement of the plunger 124 and the opening degree adjustment movement of the diaphragm 126 for the hydrogen purge flow path 113 according to the amount of current applied to the coil 122 can be performed consistently and smoothly.

By enabling the amount of current to be applied to the coil 122 according to the differential pressure between the anode and the cathode, and by enabling the opening degree (opening amount) of the hydrogen purge flow path 113 to be adjusted by the forward and backward movement of the diaphragm 126 made together with the forward and backward stroke of the plunger 124 based on the amount of current for each differential pressure applied to the coil 122, the condensate water, nitrogen, and the like, remaining in the anode of the stack can be purged to the outside through the hydrogen purge flow path 113 along with the remaining hydrogen, and the hydrogen purge amount including the condensate water, nitrogen, the remaining hydrogen, and the like, can be kept constant for each differential pressure between the anode and cathode of the stack.

After the opening degree of the hydrogen purge flow path 113 has been adjusted and the condensate water, nitrogen, and the like, remaining in the anode have been purged to the outside through the hydrogen purge flow path 113 along with the remaining hydrogen, the controller 200 can compare the hydrogen concentration of the fuel cell stack with an upper limit reference value (operation S106).

As a result of the comparison at operation S106, if the hydrogen concentration of the fuel cell stack is greater than the upper limit reference value, the controller 200 can perform an off control for closing the purge valve 100 (operation S107) because the hydrogen purge is no longer necessary.

When the current to the coil 122 is turned off, the plunger 124 can be pulled to the maximum and move forward due to the elastic restoring force in the expansion direction of the diaphragm 126, such that the diaphragm 126 closes the hydrogen purge flow path 113.

The controller 200 can be configured to perform a fail-safe function for the purge valve 100, and this fail-safe function can be intended to determine whether the function of the purge valve 100 is operating normally and to guide maintenance and replacement in response to the failure of the purge valve 100.

The controller 200 can determine that the purge valve 100 fails if a phenomenon occurs consecutively five or more times that the amount of fluid (hydrogen purge amount) containing hydrogen, water, and the like, discharged to the outside through the hydrogen purge flow path 113 does not exceed a reference amount after the opening degree of the hydrogen purge flow path 113 has been adjusted through the current control or PWM control for the purge valve 100.

For example, when confirming, based on the signal of a flow sensor (not shown) for measuring the flow rate passing through the hydrogen purge flow path 113, that a phenomenon occurs consecutively five or more times that the amount of fluid (hydrogen purge amount) containing hydrogen, water, and the like, discharged to the outside through the hydrogen purge flow path 113 does not exceed the reference amount, the controller 200 may consider the plunger 124, the diaphragm 126, and the like, to be fixed at a state where the opening degree of the hydrogen purge flow path 113 can be adjusted to be smaller than the desired level, and may determine that the purge valve 100 fails, and may control a known visual and audible alarm device to operate.

Additionally, the controller 200 can determine that the purge valve 100 fails if a phenomenon occurs consecutively five or more times that the amount of fluid (hydrogen purge amount) containing hydrogen, water, and the like, discharged to the outside through the hydrogen purge flow path 113 exceeds a reference amount after the opening degree of the hydrogen purge flow path 113 has been adjusted through the current control or PWM control for the purge valve 100.

For example, when confirming, based on the signal of a flow sensor (not shown) for measuring the flow rate passing through the hydrogen purge flow path 113, that a phenomenon occurs consecutively five or more times that the amount of fluid (hydrogen purge amount) containing hydrogen, water, and the like, discharged to the outside through the hydrogen purge flow path 113 exceeds the reference amount, the controller 200 may consider the plunger 124, the diaphragm 126, and the like, to be fixed at a state where the opening degree of the hydrogen purge flow path 113 can be adjusted to be greater than the desired level, and may determine that the purge valve 100 fails, and may control a known visual and audible alarm device to operate.

The controller 200 can determine that the purge valve 100 fails if a phenomenon occurs consecutively five or more times that fluid containing hydrogen and water is not discharged through the hydrogen purge flow path 113 from the stack after the opening degree of the hydrogen purge flow path 113 has been adjusted through the current control or PWM control for the purge valve 100.

For example, when confirming, based on the signal of a flow sensor (not shown) for measuring the flow rate passing through the hydrogen purge flow path 113, that a phenomenon occurs consecutively five or more times that fluid containing hydrogen and water is not discharged through the hydrogen purge flow path 113 from the stack, the controller 200 may consider the plunger 124, the diaphragm 126, and the like, to be fixed at the closing position, and may determine that the purge valve 100 fails, and may control a known visual and audible alarm device to operate.

The controller 200 can determine that the purge valve 100 fails if a phenomenon occurs consecutively five or more times that fluid containing hydrogen and water is discharged through the hydrogen purge flow path 113 from the stack after having performed the off control for closing the purge valve 100.

For example, when confirming, based on the signal of a flow sensor (not shown) for measuring the flow rate passing through the hydrogen purge flow path 113, that a phenomenon occurs consecutively five or more times that fluid (hydrogen purge amount) containing hydrogen and water is discharged through the hydrogen purge flow path 113 from the stack after the off control for the closure of the purge valve 100, the controller 200 may consider the plunger 124, the diaphragm 126, and the like, to be fixed at the opening position, and may determine that the purge valve 100 fails, and may control a known visual and audible alarm device to operate.

By allowing the controller 200 to perform the fail-safe function for the purge valve 100, maintenance, replacement, and the like, can be guided in response to the failure of the purge valve 100.

While the present disclosure has described an embodiment, the scope of the patent right of the present disclosure is not necessarily limited thereto, but various modifications and improvements that could be made by those skilled in the art using the concepts of the present disclosure defined in the following claims can also fall within the scope of the patent right of the present disclosure.

What is claimed is:

1. A hydrogen purge system comprising:
a purge valve having a hydrogen purge flow path and configured to be mounted on a hydrogen outlet of an anode of a fuel cell stack; and
a controller configured to perform a current control or PWM control on the purge valve to adjust an opening degree of the hydrogen purge flow path of the purge valve according to a differential pressure between the anode and a cathode of the fuel cell stack.

2. The system of claim 1, wherein the purge valve comprises:
a valve housing with the hydrogen purge flow path formed therein and configured to fluidly communicate with the hydrogen outlet of the anode;
a drive unit case mounted on the valve housing;
a coil in an inner space of the drive unit case, the coil being configured receive current based on the current control or PWM control of the controller;
a plunger configured to be movable forward and backward in the drive unit case; and
a diaphragm coupled on a front end of the plunger and configured to adjust an opening degree of the hydrogen purge flow path based on forward and backward stroke of the plunger according to an amount of current applied to the coil,
wherein a ventilation hole penetrates through the valve housing and the drive unit case, the ventilation hole being configured to maintain an internal space of the drive unit case at atmospheric pressure.

3. The system of claim 2, wherein the controller is configured to perform the current control or PWM control on the coil of the purge valve using current-hydrogen purge amount mapping data per differential pressure between the anode and the cathode, after checking a measured differential pressure between the anode and the cathode.

4. The system of claim 2, wherein the ventilation hole in the valve housing penetrates through to a first region between a first O-ring and a second O-ring, wherein the first O-ring is configured for sealing the first region of the valve housing from outside, and wherein the second O-ring is configured for sealing the first region of the valve housing from the hydrogen purge flow path.

5. The system of claim 2, wherein a vent hole in the drive unit case fluidly communicates the ventilation hole with the atmosphere.

6. The system of claim 5, wherein the vent hole includes a membrane filter therein configured for preventing reverse infiltration of moisture.

7. A method for controlling a hydrogen purge system, the method comprising:
checking a differential pressure between an anode and a cathode of a fuel cell stack;
determining an amount of current to be applied to a coil of a purge valve based on current-hydrogen purge amount mapping data per differential pressure between the anode and the cathode;
applying the determined amount of current to the coil of the purge valve by a current control or PWM control; and
adjusting an opening degree of a hydrogen purge flow path of the purge valve by a forward and backward stroke of a plunger according to the amount of current applied to the coil of the purge valve.

8. The method of claim 7, further comprising adjusting the opening degree of the hydrogen purge flow path by a diaphragm mounted on a front end of the plunger according to the amount of current applied to the coil.

9. The method of claim 7, wherein if the hydrogen concentration of the fuel cell stack is less than a lower limit reference value, checking a measured differential pressure between an anode and a cathode, and
wherein if the hydrogen concentration of the fuel cell stack is greater than an upper limit reference value after the opening degree of the hydrogen purge flow path is adjusted, performing an off control for closing the purge valve.

10. The method of claim 7, wherein the purge valve includes a valve housing having the hydrogen purge flow path therethrough, and the valve housing having a drive unit case with the coil and the plunger installed in an internal space therein, and
wherein the method further comprises maintaining the internal space of the drive unit case at atmospheric pressure via a ventilation hole in and fluidly communicating through the valve housing and the drive unit case, and via a vent hole in the drive unit case that fluidly communicates with the ventilation hole.

11. The method of claim 7, further comprising determining that the purge valve fails if a phenomenon occurs consecutively five or more times that an amount of fluid containing hydrogen and water discharged to outside through the hydrogen purge flow path does not exceed a reference amount after the opening degree of the hydrogen purge flow path is adjusted through the current control or PWM control for the purge valve.

12. The method of claim 7, further comprising determining that the purge valve fails if a phenomenon occurs consecutively five or more times that an amount of fluid containing hydrogen and water discharged to outside through the hydrogen purge flow path exceeds a reference amount after the opening degree of the hydrogen purge flow path is adjusted through the current control or PWM control for the purge valve.

13. The method of claim 7, further comprising determining that the purge valve fails if a phenomenon occurs consecutively five or more times that fluid containing hydrogen and water is not discharged through the hydrogen purge flow path after the opening degree of the hydrogen purge flow path is adjusted through the current control or PWM control for the purge valve.

14. The method of claim 7, further comprising determining that the purge valve fails if a phenomenon occurs consecutively five or more times that fluid containing hydrogen and water is discharged through the hydrogen purge flow path after an off control for closing the purge valve.

15. A fuel cell vehicle comprising:
a fuel cell stack in which multiple unit cells are stacked to generate electricity using electrochemical reactions of hydrogen and oxygen;
a purge valve having a hydrogen purge flow path and configured to be mounted on a hydrogen outlet of an anode of the fuel cell stack; and
a controller configured to perform a current control or PWM control on the purge valve to adjust an opening degree of the hydrogen purge flow path of the purge valve according to a differential pressure between the anode and a cathode of the fuel cell stack.

16. The fuel cell vehicle of claim 15, wherein the purge valve comprises:
a valve housing with the hydrogen purge flow path formed therein and configured to fluidly communicate with the hydrogen outlet of the anode;
a drive unit case mounted on the valve housing;
a coil in an inner space of the drive unit case, the coil being configured receive current based on the current control or PWM control of the controller;
a plunger configured to be movable forward and backward in the drive unit case; and
a diaphragm coupled on a front end of the plunger and configured to adjust an opening degree of the hydrogen purge flow path based on forward and backward stroke of the plunger according to an amount of current applied to the coil,
wherein a ventilation hole penetrates through the valve housing and the drive unit case and the ventilation hole being configured to maintain an internal space of the drive unit case at atmospheric pressure.

17. The fuel cell vehicle of claim 16, wherein the controller is configured to perform the current control or PWM control on the coil of the purge valve using current-hydrogen purge amount mapping data per differential pressure between the anode and the cathode, after checking a measured differential pressure between the anode and the cathode.

18. The fuel cell vehicle of claim 16, wherein the ventilation hole in the valve housing penetrates through to a first region between a first O-ring and a second O-ring, wherein the first O-ring is configured for sealing the first region of the valve housing from outside, and wherein the second O-ring is configured for sealing the first region of the valve housing from the hydrogen purge flow path.

19. The fuel cell vehicle of claim 16, wherein a vent hole in the drive unit case fluidly communicates the ventilation hole with the atmosphere.

20. The fuel cell vehicle of claim 19, wherein the vent hole includes a membrane filter therein configured for preventing reverse infiltration of moisture.
